(19) United States
(12) Patent Application Publication
(10) Pub. No.: US 2011/0232487 A1
(43) Pub. Date: Sep. 29, 2011

(54) APPARATUS FOR PROCESSING EXHAUST GAS IN NONFERROUS SMELTING FACILITIES, AND METHOD FOR PROCESSING EXHAUST GAS IN NONFERROUS SMELTING FACILITIES

(76) Inventors: Hidekazu NAKATA, Oita-shi (JP); Toshihiro Kamegai, Oita-shi (JP); Takashi Ito, Oita-shi (JP); Akira Kimura, Oita-shi (JP)

(21) Appl. No.: 13/072,210

(22) Filed: Mar. 25, 2011

(30) Foreign Application Priority Data
Mar. 26, 2010 (JP) 2010-073247

(51) Int. Cl. B01D 47/06

(52) U.S. Cl. 95/151; 96/240

(57) ABSTRACT

An exhaust-gas processing apparatus in nonferrous smelting facilities includes: a tower that removes particulate impurities from an exhaust gas emitted from a furnace by spraying a circulating liquid onto the exhaust gas, and deposits the circulating liquid in a lower portion of the tower, the impurities being suspended in the circulating liquid; a pipe in which the circulating liquid deposited in the lower portion of the tower circulates; and a filtering device that has the pipe connected thereto, and captures and filters the circulating liquid having the impurities suspended therein, the filtering device continuously removing the impurities from the circulating liquid, the filtering device packing the removed impurities into containers.

### BACKGROUND OF THE INVENTION

1. Field of the Invention

The present invention relates to collection of particulate impurities captured in a cooling circulating liquid during the process to clean and cool an exhaust gas emitted as a result of nonferrous smelting.

2. Description of the Related Art

The SO₂ gas emitted as a result of combustion of sulfide ore in nonferrous smelting facilities is refined with the use of facilities such as a cleaning tower, a cooling tower, and a Wet electrostatic precipitator. The SO₂ gas is then sent to a sulfuric acid production process. In the cleaning tower and the cooling tower, impurities containing valuable metals such as Se and Pb are removed from the SO₂ gas by spraying a circulating liquid. The impurities are captured in the circulating liquid, and the SO₂ gas is cooled down.

Japanese Laid-Open Patent Publication No. 2006-255573 discloses exhaust-gas cleaning and cooling towers that restrain degradation of the inner walls of the cleaning and cooling towers in nonferrous smelting facilities, to prolong the lives of the towers. Cleaning and cooling spray devices can be easily attached to and detached from the exhaust-gas cleaning and cooling towers.

Meanwhile, the impurities captured in the circulating liquid turn into suspended solids (SS), and the SS are partially deposited in the lower portions of the cleaning tower and the cooling tower. The SS also partially accumulate in circulating liquid facilities such as spray chips, a circulating liquid cooler, a cooling tower filler, and a circulation acid pipe. The SS accumulating in the spray chips, the circulating liquid cooler, the cooling tower filler, and the circulation acid pipe causes blockage of the circulating liquid path, and becomes the main cause of a decrease in facility capacity. Elimination of the blockage is performed during operations whenever necessary, but such a process requires an enormous amount of money.

The impurities (SS) accumulating in the lower portions of the cleaning tower and the cooling tower are removed from the inside when the operation of the plant is stopped over a long period of time such as a regular shutdown scheduled once a year. The removed impurities are dried, and are packed into drums. After subjected to demercuration, the impurities packed in drums are sent to a valuable metal recovering process. Since the valuable metals contained in the impurity sludge are left until a long-time stoppage, time loss due to the long-time accumulation is caused. If valuable metals remain in the cleaning tower and the cooling tower for a long period of time, the valuable metals cause a “stagnant interest rate”, which is undesirable. If such valuable metals are continuously collected and are constantly processed, the collected valuable metals can be sold, and the stagnant interest rate can be lowered.

By conventional techniques, impurities are removed from towers and are packed into drums by humans. Therefore, the labor costs become large, and a large amount of labor is also required in securing environment safety to prevent scatter of mercury dust and exposure of workers to mercury.

### SUMMARY OF THE INVENTION

It is therefore an object of the present invention to provide an exhaust-gas processing apparatus in nonferrous smelting facilities and a method for processing an exhaust gas in nonferrous smelting facilities in which the above disadvantages are eliminated.

A more specific object of the present invention is to restrain blockage of pipes in which circulating liquids circulate, and lighten the workloads required to remove impurities.

The above objects of the present invention are achieved by an exhaust-gas processing apparatus in nonferrous smelting facilities that includes: a tower that removes particulate impurities from an exhaust gas emitted from a furnace by spraying a circulating liquid onto the exhaust gas, and deposits the circulating liquid in a lower portion thereof, the impurities being suspended in the circulating liquid; a pipe in which the circulating liquid deposited in the lower portion of the tower circulates; and a filtering device that has the pipe connected thereto, and captures and filters the circulating liquid having the impurities suspended therein, the filtering device continuously removing the impurities from the circulating liquid, the filtering device packing the removed impurities into containers.

With this structure, the following effects are achieved.

(1) As the impurities are removed from the circulating liquid, clogging of the circulation acid pipe and the circulating liquid filling unit can be restrained. Accordingly, the labor required to eliminate the clogging can be reduced, and the operating costs can also be reduced.

(2) As the manual labor required to remove the accumulating impurities and pack the impurities into drums is reduced, the workloads of the workers in charge of the impurity removal are lightened, and the maintenance costs for environmental safety to prevent exposure to mercury can be lowered.

(3) The valuable resources contained as impurities can be removed in early stage, and the “stagnant interest rate” can be lowered.

In the exhaust-gas processing apparatus in nonferrous smelting facilities, the circulating liquid may be supplied into the filtering device during an exhaust-gas processing operation. With this arrangement, the impurities in the circulating liquid can be continuously removed, without a stop in the exhaust-gas processing procedures.

In the exhaust-gas processing apparatus in nonferrous smelting facilities, the filtering device may include: a first filter that captures and filters the circulating liquid having the impurities suspended therein, and separates the impurities; and a second filter that filters a liquid formed by turning the impurities separated by the first filter into slurry and collecting the slurry, and separates the impurities. The impurities separated by the second filter may be packed into containers. Also, the exhaust-gas processing apparatus in nonferrous smelting facilities may further include a storage tank that stores filtrate processed by the first filter. In this structure, the filtrate stored in the storage tank may be supplied to the first filter, to turn the impurities separated by the first filter into the slurry.

In the exhaust-gas processing apparatus in nonferrous smelting facilities, the filtering device may include a first filter that captures and filters the circulating liquid having the impurities suspended therein, and separates the impurities. Most of the filtrate generated in the first filter is returned to the lower portions of a cleaning tower and a cooling tower, and part of the first filtrate is stored as filter cloth backwashing water in a storage tank that is provided independently of other components. The filtering device may further include a second filter that turns filtered substances into slurry with the filter cloth backwashing water when the amount of substances filtered by the first filter reaches a certain amount, and separates the slurry as second filtered substances. The second filtered substances separated by the second filter may be packed into containers. In such a two-stage filter operation, clogging of the filter cloths starts forming as the filtration progresses in the first stage of the filtration procedures. The filter cloths of the first-stage filter are washed with the filter cloth backwashing water stored separately, and the filtered substances are removed as slurry before the filter capacity rapidly drops. The slurry is then collected as solid substances by the second-stage filter. Accordingly, the filter capacity of the entire processing facilities can be improved. Here, a decrease in filter capacity might be caused due to clogging during the process to filter the slurry in the second-stage filter. However, this does not affect the removal of impurities from the circulating liquids to be supplied to the cleaning tower and the cooling tower. As a result, the filter capacity of the entire processing facilities is improved.

Also, in the exhaust-gas processing apparatus in nonferrous smelting facilities, the operations in the filtering device may be performed in a negatively-pressurized, hermetically-sealed state. Accordingly, scatter of impurity particles can be prevented, and exposure of workers to mercury can also be prevented.

Also, the exhaust-gas processing apparatus in nonferrous smelting facilities is capable of processing an exhaust gas emitted during a sulfuric acid process in copper smelting. In other words, the exhaust gas is an exhaust gas emitted during a sulfuric acid process in copper smelting.

Also, in the exhaust-gas processing apparatus in nonferrous smelting facilities, the particulate impurities may contain a valuable metal, and the valuable metal may be collected into the containers. Accordingly, valuable metals contained in the exhaust gas emitted during the heat treatment in copper smelting or waste plastic processing can be collected in early stage.

The above objects of the present invention are also achieved by a method for processing an exhaust gas in nonferrous smelting facilities. This method includes: a first process to remove particulate impurities from an exhaust gas emitted from a furnace by spraying a circulating liquid onto the exhaust gas, and deposit the circulating liquid, the impurities being suspended in the circulating liquid; a second process to continuously remove the impurities from the circulating liquid by capturing and filtering the circulating liquid having the impurities suspended therein; and a third process to pack the impurities removed from the circulating liquid into containers.

In the method for processing an exhaust gas in nonferrous smelting facilities, the second process may be carried out during an exhaust-gas processing operation.

In the method for processing an exhaust gas in nonferrous smelting facilities, the second process may include: a fourth process to separate the impurities by capturing and filtering the circulating liquid having the impurities suspended therein; and a fifth process to separate the impurities by filtering a liquid formed by turning the impurities separated in the fourth process into slurry and collecting the slurry. During the third process, the impurities separated in the fifth process may be packed into containers.

In the method for processing an exhaust gas in nonferrous smelting facilities, filtrate processed in the fourth process may be supplied to turn the impurities separated in the fourth process into slurry during the fifth process.

In the method for processing an exhaust gas in nonferrous smelting facilities, the third process may be carried out in a negatively-pressurized, hermetically-sealed state.

In the method for processing an exhaust gas in nonferrous smelting facilities, the exhaust gas may be an exhaust gas emitted during a sulfuric acid process in copper smelting.

In the method for processing an exhaust gas in nonferrous smelting facilities, the particulate impurities may contain a valuable metal, and the valuable metal may be collected into the containers.

As described above, an exhaust-gas processing apparatus in nonferrous smelting facilities according to the present invention can restrain blockage of pipes in which circulating liquids circulate, and lighten the workloads required to remove impurities.

### BRIEF DESCRIPTION OF THE DRAWINGS

Other objects, features and advantages of the present invention will become more apparent from the following detailed description when read in conjunction with the accompanying drawings, in which:

FIG. 1 is an explanatory view schematically showing the structure of an exhaust-gas processing apparatus according to a first embodiment;

FIG. 2 is an explanatory view schematically showing the inner structure of a Fundabac filter; and

FIG. 3 is an explanatory view schematically showing the structure of an exhaust-gas processing apparatus according to a second embodiment.

### DESCRIPTION OF THE PREFERRED EMBODIMENTS

The following is a detailed description of embodiments for carrying out the invention, with reference to the accompanying drawings.

### First Embodiment

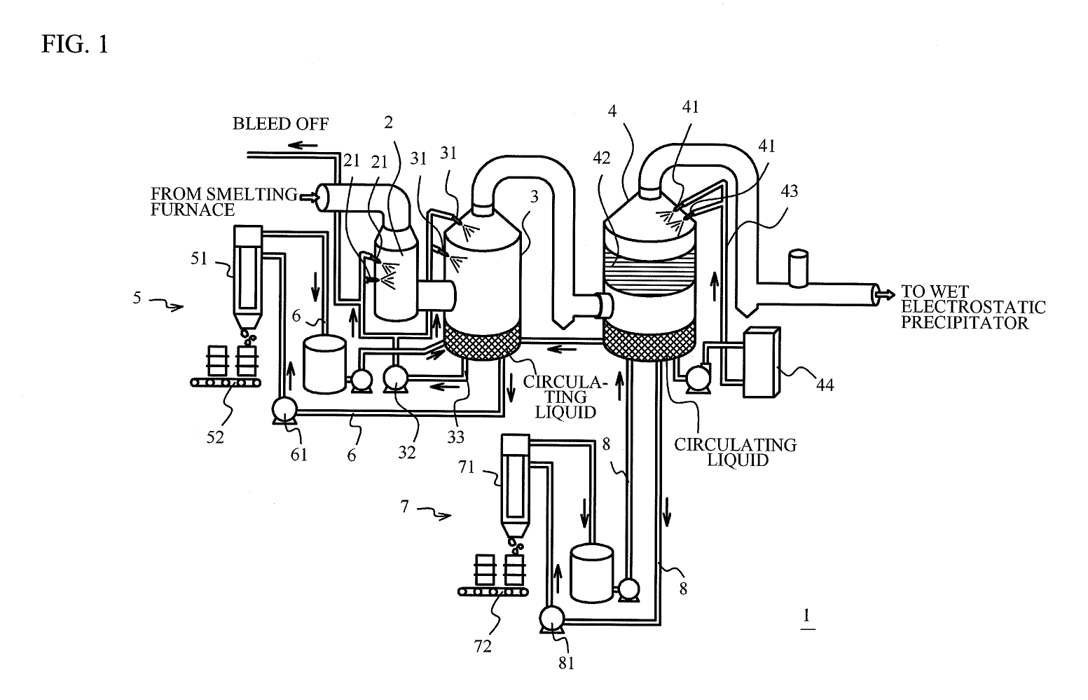

Referring to the drawings, the structure of an apparatus according to this embodiment is described. FIG. 1 is an explanatory view schematically showing the structure of an exhaust-gas processing apparatus 1 of this embodiment. The exhaust-gas processing apparatus 1 is an apparatus that processes the SO₂ gas emitted as a result of combustion of sulfide ore in nonferrous smelting facilities. The exhaust-gas processing apparatus 1 includes a precooling tower 2, a cleaning tower 3, and a cooling tower 4. The SO₂ gas flows from a flash smelting furnace (not shown) into the exhaust-gas processing apparatus 1. The SO₂ gas passes through the precooling tower 2, the cleaning tower 3, and the cooling tower 4 in this order. During that time, the SO₂ gas is cooled and cleaned, and is sent to a sulfuric acid plant (not shown). The temperature of the SO₂ gas is 300° C. before the SO₂ gas passes through the exhaust-gas processing apparatus 1. The temperature then drops to 40° C. while the SO₂ gas passes through the exhaust-gas processing apparatus 1.

The precooling tower 2 has a spray unit 21 that sprays a circulating liquid onto the exhaust gas flowing into the tower, to clean and cool the SO₂ gas. The circulating liquid is supplied from a lower portion of the cleaning tower 3 to the spray unit 21 via a circulation pump 32. The SO₂ gas emitted from the flash smelting furnace contains particulate impurities containing Se- and Pb-based valuable metals. By spraying the circulating liquid from the spray unit 21, the particulate impurities are suspended in the circulation liquid, and turn into suspended solids (SS). As a result, the particulate impurities are deposited in the lower portion of the cleaning tower 3.

Like the precooling tower 2, the cleaning tower 3 also has a spray unit 31 that sprays a circulating liquid onto the exhaust gas flowing into the tower, to clean the SO₂ gas. By spraying the circulating liquid from the spray unit 31 of the cleaning tower 3, the particulate impurities that have not been removed from the SO₂ gas in the precooling tower 2 are suspended in the circulating liquid, and turn into SS. The particulate impurities are then deposited in the lower portion of the cleaning tower 3. The circulating liquid is supplied from the lower portion of the cleaning tower 3 to the spray unit 31 via the circulation pump 32. The circulating liquids are supplied to the spray unit 21 and the spray unit 31 by the circulation pump 32 performing pressure-feeding at 8000 L/min.

Like the precooling tower 2 and the cleaning tower 3, the cooling tower 4 has a spray unit 41 that cleans and cools the SO₂ gas. The cooling tower 4 is equipped with a filling unit 42. A circulating liquid sprayed onto the upper portion of the filling unit 42 by the spray unit 41 is dispersed in the filling unit 42. The exhaust gas flowing from the lower portion of the filling unit 42 and passing through the cleaning tower 3 is dispersed in the filling unit 42, and is cooled by the circulating liquid in the filling unit 42.

The circulating liquid in the cooling tower 4 captures the impurities in the exhaust gas, and is deposited in the lower portion of the cooling tower 4. The circulating liquid deposited in the lower portion of the cooling tower 4 is cooled by a cooler 44, and is supplied to the spray unit 41 through a circulation acid pipe 43. The circulating liquid is supplied to the spray unit 41 at 9000 L/min.

The exhaust-gas processing apparatus 1 of this embodiment further includes a filtering device 5 that filters the circulating liquid that circulates in the cleaning tower 3. The filtering device 5 includes a Fundabac filter 51 and a drum packing system 52. A pipe 6 connected to the lower portion of the cleaning tower 3 is connected to the Fundabac filter 51. The circulating liquid deposited in the lower portion of the cleaning tower 3 circulates in the pipe 6. A pump 61 is placed in the pipe 6, and pressure-feeds the circulating liquid from the cleaning tower 3 into the Fundabac filter 51. The pump 61 is operated during the exhaust-gas processing, and is capable of constantly sending the circulating liquid from the cleaning tower 3 into the Fundabac filter 51.

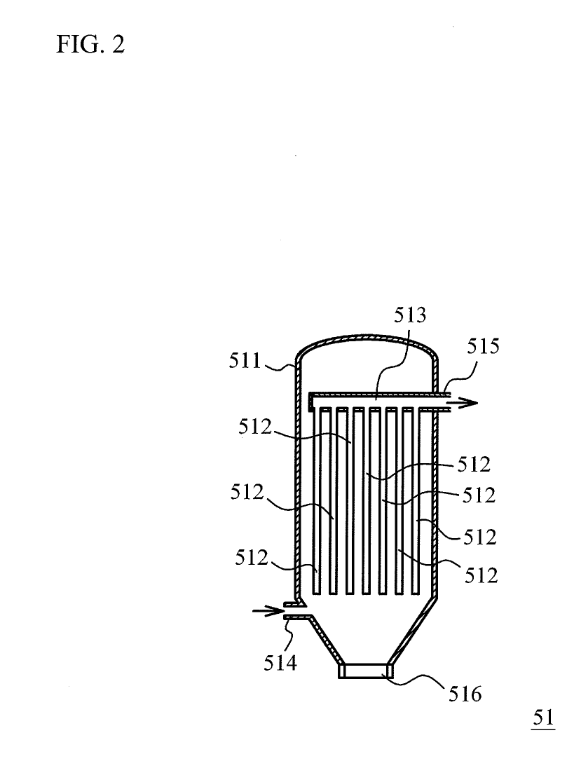

FIG. 2 is an explanatory view schematically showing the inner structure of the Fundabac filter 51. The Fundabac filter 51 has a vessel 511. Filter elements 512 each having its outer periphery covered with a filter cloth, and a pipe 513 connected to the upper portions of the filter elements 512 are provided in the vessel 511. The circulating liquid to be filtered is pressure-fed from the pump 61, and is introduced through an inlet 514 at the lower portion of the vessel 511. The circuiting liquid is filtered when passing through the filter cloths of the filter elements 512. The material of the filter cloths may be synthetic fiber such as polypropylene, polyester, or polyphenylene sulfide. The mesh size of the filter cloths is 5 μm, and the filter cloths are used with an air permeability of 1 cc/cm²·sec or lower. After the filtration, the filtrate passes through the pipe 513, and is guided into the pipe 6 through an outlet 515 at the upper portion.

The filtrate is then returned into the cleaning tower 3. Meanwhile, the filtered substances adhering to the filter cloths of the filter elements 512 can be collected in a solid form through a discharge outlet 516 at the lower portion of the vessel 511 by blowing back air after air drying. Instead of air, water or a filtrate is supplied, and the filtered substances may be collected in the form of slurry by performing backwashing. The Fundabac filter 51 has excellent corrosion-resistant characteristics, and is capable of filtering the circulating liquid during an exhaust-gas processing operation. The filtered substances in a solid or slurry form are packed into drums in the drum packing system 52 located below the Fundabac filter 51, and are sent to the demercuration stage. The operation to pack the filtered substances into drums is performed in a negatively-pressurized, hermetically-sealed state.

The substances filtered by the Fundabac filter 51, which are the impurities (SS) suspended in the circulating liquid, are particles of 50 μm or less in particle size, and contain Hg. Other than Hg, the filtered substances contain valuable metals at the following composition rates: 40 to 60 wt % of Se, 5 to 30 wt % of Pb, 0 to 10 weight ppm of Au, and 50 to 200 weight ppm of Ag.

A filtering device 7 that has the same structure as the filtering device 5 is also mounted in the cooling tower 4. The filtering device 7 includes a Fundabac filter 71 and a drum packing system 72. The Fundabac filter 71 is the same as the Fundabac filter 51. The drum packing system 72 is the same as the drum packing system 52. A pipe 8 that is connected to the lower portion of the cooling tower 4 is connected to the Fundabac filter 71. The circulating liquid deposited in the lower portion of the cooling tower 4 circulates in the pipe 8. A pump 81 is placed in the pipe 8, and the circulating liquid in the cooling tower 4 is sent to the Fundabac filter 71.

The substances to be filtered by the Fundabac filter 71 and the composition rates in the filtered substances are the same as those in the case of the Fundabac filter 51.

Next, the advantageous effects of the exhaust-gas processing apparatus 1 are described. Having the filtering devices 5 and 7 incorporated thereinto, the exhaust-gas processing apparatus 1 has the following advantageous effects.

(1) The labor required for the impurity removal that is performed by humans during a long-term stoppage such as a scheduled shutdown is reduced. Accordingly, the workloads of the workers can be lightened, and the costs required for maintaining environmental safety to prevent exposure to mercury can be lowered.

(2) Since the removal is carried out only when the plant operation is stopped for a long period of time, impurities are mixed in the circulating liquids supplied to the spray units 21, 31, and 41, resulting in clogging of the spray units 21, 31, and 41, the filling unit 42, the circulation acid pipe 43, and the cooler 44. In this embodiment, the impurities are constantly filtered by the filtering devices 5 and 7. Accordingly, only smaller clogging of the spray units 21, 31, and 41, the filling unit 42, the circulation acid pipes 33 and 43, and the cooler 44 can be expected, compared with the clogging in conventional cases. Thus, the labor and costs required in eliminating the clogging can be reduced.

(3) Further, as a circulating liquid is sprayed onto the exhaust gas, the valuable metals such as Se, Pb, Au, and Ag contained in the exhaust gas are suspended together with dust in the circulating liquids, and are then deposited in the towers. If such valuable metals remain deposited in the towers, they turn out to be the cause of a “stagnant interest rate”, which results in poor efficiency. In the exhaust-gas processing apparatus of this embodiment, the impurities that contain valuable metals and are deposited in the towers are constantly removed and filtered. Accordingly, the time loss conventionally caused by the valuable metals remaining in the towers can be eliminated, and the stagnant interest rate can be lowered. Where the amount of impurities recovered is 45 t per annum, and 40 wt % of Se are contained in the recovered impurities, the amount of Se recovered is 18 t per annum. If the sales price of Se is 5000 yen/kg, and the interest rate is 0.85%, the stagnant interest rate can be lowered by the amount equivalent to 770,000 yen.

(4) Also, the impurities in the circulating liquids can be continuously removed, without a stop in the exhaust-gas processing procedures. In conventional operations, the process to remove the impurities in exhaust-gas processing facilities is carried out in conjunction with the operations of the flash smelting furnace, and therefore, is carried out when the flash smelting furnace is maintained and repaired on a regular basis. In the present invention, however, the process to continuously remove the impurities can be carried out, regardless of the operations of the flash smelting furnace. Accordingly, the operating efficiency of the facilities is dramatically improved.

(5) Further, in the process to collect the impurities, the collected impurities are packed into drums in a negatively-pressurized, hermetically-sealed state. Accordingly, scatter of impurity particles containing mercury can be prevented, and exposure of the workers to mercury can also be prevented.

### Second Embodiment

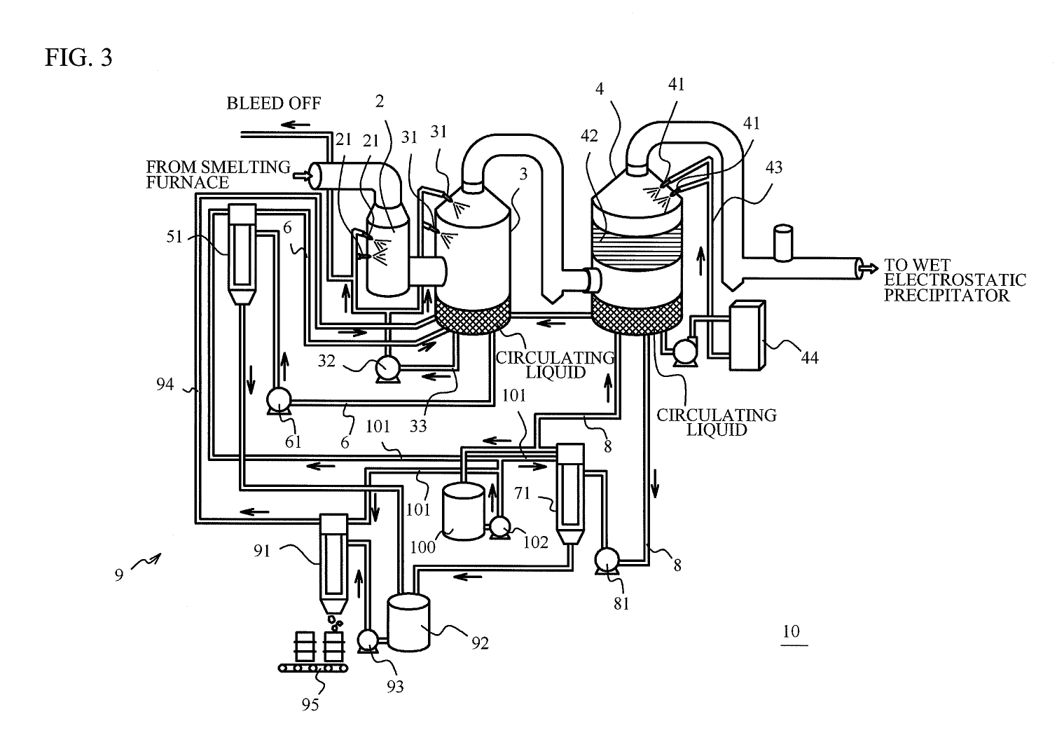

Next, a second embodiment of the present invention is described. The structures of devices in an exhaust-gas processing apparatus 10 of this embodiment are described, with reference to the accompanying drawings. FIG. 3 is an explanatory view schematically showing the structure of the exhaust-gas processing apparatus 10 of this embodiment. The exhaust-gas processing apparatus 10 of this embodiment differs from the exhaust-gas processing apparatus 1 of the first embodiment in the structure of a filtering device for filtering a circulating liquid. More specifically, the structures of the precooling tower, the cleaning tower, and the cooling tower through which the SO₂ gas emitted from the flash smelting furnace passes are the same as those of the exhaust-gas processing apparatus 1 of the first embodiment. In the drawing, the same components as those of the exhaust-gas processing apparatus 1 of the first embodiment are denoted by the same reference numerals as those used in the first embodiment, and explanation of them is omitted herein. The exhaust gas to be processed is the same as that in the first embodiment, and the composition of the impurities is the same as that in the first embodiment.

A filtering device 9 of this embodiment includes Fundabac filters 51, 71, and 91, and a filter cloth backwashing water tank 100 that stores washing water. The Fundabac filters 51, 71, and 91 each have the same structure as that of the Fundabac filter 51 described in the first embodiment. A pipe 6 that is connected to the lower portion of the cleaning tower 3 is connected to the Fundabac filter 51. The circulating liquid deposited in the lower portion of the cleaning tower 3 circulates in the pipe 6. A pipe 101 that is connected to the filter cloth backwashing water tank 100 and supplies the filter cloth backwashing water from the filter cloth backwashing water tank 100 into the Fundabac filter 51 is also connected to the Fundabac filter 51.

The Fundabac filter 51 captures and filters the circulating liquid that is deposited in the lower portion of the cleaning tower 3 and has impurities suspended therein. The Fundabac filter 51 separates the impurities from the circulating liquid. After the filtration, the circulating liquid returns to the cleaning tower 3 through the pipe 6. When the filtered substances in the Fundabac filter 51 are removed, the pump 61 is stopped, and the supply of the circulating liquid from the cleaning tower 3 is suspended. The filter cloth backwashing water in the filter cloth backwashing water tank 100 is sent into the Fundabac filter 51 by the pressure-feeding performed by a washing water pump 102 placed in the pipe 101. The filter cloth backwashing water in the filter cloth backwashing water tank 100 is part of the circulating liquid filtered by the Fundabac filter 71. Alternatively, the circulating liquid filtered by the Fundabac filter 51 may be stored as the filter cloth backwashing water in the filter cloth backwashing water tank 100.

The washing water supplied to the Fundabac filter 51 in this manner flows from the outlet 515 into the pipe 513 in the Fundabac filter 51. As the washing water flows in the opposite direction from the flow in the regular filter operations, the filtered substances captured by the filter cloths of the filter elements 512 are temporarily turned into liquid slurry, and are then detached from the filter cloths. The washing water in the slurry state that has the filtered substances (impurities) suspended therein is then discharged through the discharge outlet 516. As described above, when the impurities separated by the Fundabac filter 51 are turned into slurry, the filtrate filtered by the Fundabac filters 51 and 61 can be supplied. The flows of the circulating liquid can be controlled by switching flow paths for regular filtration and filtered substance collection, with the use of a three-way valve or the like.

The washing water that is discharged through the discharge outlet 516 and has the impurities suspended therein is sent to a filtered substance tank 92, and is temporarily stored in the filtered substance tank 92. The washing water having the impurities suspended therein is pressure-fed from the filtered substance tank 92 to the Fundabac filter 91 by a pump 93 when appropriate, and is filtered in the Fundabac filter 91. After the filtration, the filtrate passes through a pipe 94, and returns to the cleaning tower 3. Meanwhile, the filtered substances removed from the washing water in the Fundabac filter 91 are put into a solid state by blowing back air after air drying. After that, the filtered substances are packed into drums in a drum packing system 95 located below the Fundabac filter 91, and are sent to the demercuration stage. The process to pack the filtered substances into drums is carried out in a negatively-pressurized, hermetically-sealed state. Instead of air, the filter cloth backwashing water may be supplied from the filter cloth backwashing water tank 100, and the filtered substances may be backwashed and collected in the form of slurry.

A pipe 8 that is connected to the lower portion of the cooling tower 4 is connected to the Fundabac filter 71. The circulating liquid deposited in the lower portion of the cooling tower 4 circulates in the pipe 8. A pipe 101 that is connected to the filter cloth backwashing water tank 100 and supplies the filter cloth backwashing water is connected to the Fundabac filter 71.

The Fundabac filter 71 captures and filters the circulating liquid that is deposited in the lower portion of the cooling tower 4 and has impurities suspended therein. The Fundabac filter 71 separates the impurities from the circulating liquid. After the filtration, the circulating liquid returns to the cleaning tower 3 through the pipe 8. When the filtered substances in the Fundabac filter 71 are removed, the pump 81 is stopped, and the supply of the circulating liquid from the cooling tower 4 is suspended. The filter cloth backwashing water in the filter cloth backwashing water tank 100 is sent into the Fundabac filter 71 by the pressure-feeding performed by the washing water pump 102 placed in the pipe 101. Accordingly, the washing water flows in the opposite direction from the flow in regular filter operations. The filtered substances are turned into liquid slurry, and are removed from the Fundabac filter 71. The washing water removed from the Fundabac filter 71 is sent to the Fundabac filter 91. The processing to be performed in the Fundabac filter 91 is the same as above.

In the above manner, the impurities deposited in the bottom portion of the cleaning tower 3 are filtered in a stepwise manner with the use of the Fundabac filter 51 and the Fundabac filter 91 in the exhaust-gas processing apparatus 10. Likewise, the impurities deposited in the bottom portion of the cooling tower 4 are filtered in a stepwise manner with the use of the Fundabac filter 71 and the Fundabac filter 91. In such a stepwise filter operation, impurities are removed from the circulating liquids circulating in the cleaning tower 3 and the cooling tower 4, or the circulating liquids circulating in the pipe 6 and the pipe 8, by the first-stage filtration, or the filtration by the Fundabac filter 51 and the filtration by the Fundabac filter 71. Through the filtration, clogging of the spray units 21, 31, and 41, the filling unit 42, the circulation acid pipe 43, and the cooler 44 is restrained. Meanwhile, impurities are removed from the exhaust-gas processing apparatus 10 by the second-stage filtration, or the filtration by the Fundabac filter 91. In this manner, the filters are connected in series, to perform separate operations. With this arrangement, clogging of the filter cloths in the first-stage Fundabac filter is restrained, and the filter capacity is improved.

In a filtration test using a test machine of the exhaust-gas processing apparatus 10 having the above described structure, a filtration rate of 310 L/min was obtained in each of the Fundabac filters 51 and 71. As for the filter capacity, the impurity density of 150 to 270 mg/L observed prior to filtration by the Fundabac filter 51 is lowered to 0 to 50 mg/L after the filtration. The impurity density of 60 to 80 mg/L observed prior to filtration by the Fundabac filter 71 is lowered to 0 to 50 mg/L after the filtration.

In the exhaust-gas processing apparatus 10, the pumps 61, 81, and 93 are switched on and off, to filter the circulating liquids in a continuous manner or in an intermittent manner. The timing to discharge slurry from the Fundabac filters 51 and 71 is determined by the thickness of the filtered substances captured by the filter cloths, and such a thickness as to discharge slurry is selected from the range of 5 to 20 mm.

The operating cycles of the Fundabac filter 51 are repetitions of the followings: (1) continuing filtration until the thickness of the filtered substances adhering to the filter cloths reaches a certain thickness (approximately 5 hours); (2) discharging slurry (approximately 0.6 hours); and (3) performing refiltration. The operating cycles of the Fundabac filter 71 are the same as above. However, since the impurity density in the circulating liquid to be processed is lower, the filtration time is longer than the filtration time in each operation of the Fundabac filter 51.

On the other hand, the operating cycles of the Fundabac filter 91 are repetitions of the followings: (1) continuing filtration until the thickness of the filtered substances adhering to the filter cloths reaches a certain thickness (approximately 0.7 hours); (2) discharging the filtered substances (approximately 0.7 hours); (3) replenishing the slurry liquid (approximately 2 hours); and (4) performing refiltration. Accordingly, the operations are intermittent operations, involving a standby period every time the slurry liquid is replenished.

Next, the advantageous effects of the exhaust-gas processing apparatus 10 are described. Having the filtering device 9 incorporated thereinto, the exhaust-gas processing apparatus 10 has the following advantageous effects.

(1) The labor required for the impurity removal is reduced. Accordingly, the workloads of the workers can be lightened, and the costs required for maintaining environmental safety to prevent exposure to mercury can be lowered.

(2) In this embodiment, impurities can be constantly filtered by the filtering device 9. Accordingly, the impurity density in the circulating liquids can be lowered from 60 to 270 mg/L, which is the impurity density at the present time, to 50 mg/L or lower. With this arrangement, the clogging of the spray units 21, 31, and 41, the filling unit 42, the circulation acid pipes 33 and 43, and the cooler 44 can be reduced to ⅓ of the current amount of clogging. As a result, the labor and costs required in eliminating the clogging can be reduced.

(3) Further, in the exhaust-gas processing apparatus of this embodiment, the impurities that are deposited in towers and contain valuable metals are constantly removed and filtered. Accordingly, the time loss caused by the impurities remaining in the towers in conventional cases can be eliminated, and the stagnant interest rate can be lowered.

(4) Also, the impurities in the circulating liquids can be continuously removed, without a stop in the exhaust-gas processing procedures. In conventional operations, the process to remove the impurities in exhaust-gas processing facilities is carried out in conjunction with the operations of the flash smelting furnace, and therefore, is carried out when the flash smelting furnace is maintained and repaired on a regular basis. In the present invention, however, the process to continuously remove the impurities can be carried out, regardless of the operations of the flash smelting furnace. Accordingly, the operating efficiency of the facilities is dramatically improved.

(5) Further, in the process to collect the impurities, the collected impurities are packed into drums in a negatively-pressurized, hermetically-sealed state. Accordingly, scatter of impurity particles containing mercury can be prevented, and exposure of the workers to mercury can also be prevented.

(6) By collecting filtered substances in a stepwise manner, the filtered substances separated by the Fundabac filter in the first stage are turned into slurry, and are then filtered and collected by the Fundabac filter in the second stage. Accordingly, the filter capacity of the entire filtering devices can be improved. For example, a filter capacity approximately ten times higher than the filter capacity of one filter can be achieved. In other words, where ten Fundabac filters are normally required, two Fundabac filters are enough to perform the processing, and therefore, the costs can be ⅕ of the costs required in conventional cases. Since the second-stage Fundabac filter carries out two lines of procedures in the present invention, the three Fundabac filters are enough to handle the workloads of twenty Fundabac filters. Accordingly, the costs can be made as low as 3/20 of the costs required in conventional cases.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An exhaust-gas processing apparatus in nonferrous smelting facilities, comprising:
a tower that removes particulate impurities from an exhaust gas emitted from a furnace by spraying a circulating liquid onto the exhaust gas, and deposits the circulating liquid in a lower portion thereof, the impurities being suspended in the circulating liquid;
a pipe in which the circulating liquid deposited in the lower portion of the tower circulates; and
a filtering device that has the pipe connected thereto, and captures and filters the circulating liquid having the impurities suspended therein, the filtering device continuously removing the impurities from the circulating liquid, the filtering device packing the removed impurities into containers.

2. The exhaust-gas processing apparatus in nonferrous smelting facilities as claimed in claim 1, wherein the circulating liquid is supplied into the filtering device during an exhaust-gas processing operation.

3. The exhaust-gas processing apparatus in nonferrous smelting facilities as claimed in claim 1, wherein
the filtering device includes:
a first filter that captures and filters the circulating liquid having the impurities suspended therein, and separates the impurities; and
a second filter that filters a liquid formed by turning the impurities separated by the first filter into slurry and collecting the slurry, and separates the impurities, and
the impurities separated by the second filter are packed into containers.

4. The exhaust-gas processing apparatus in nonferrous smelting facilities as claimed in claim 3, further comprising
a storage tank that stores filtrate processed by the first filter,
wherein the filtrate stored in the storage tank is supplied to the first filter, to turn the impurities separated by the first filter into the slurry.

5. The exhaust-gas processing apparatus in nonferrous smelting facilities as claimed in claim 1, wherein the packing in the filtering device is performed in a negatively-pressurized, hermetically-sealed state.

6. The exhaust-gas processing apparatus in nonferrous smelting facilities as claimed in claim 1, wherein the exhaust gas is an exhaust gas emitted during a sulfuric acid process in copper smelting.

7. The exhaust-gas processing apparatus in nonferrous smelting facilities as claimed in claim 1, wherein the particulate impurities contain a valuable metal, and the valuable metal is collected into the containers.

8. A method for processing an exhaust gas in nonferrous smelting facilities, comprising the steps of:
removing particulate impurities from an exhaust gas emitted from a furnace by spraying a circulating liquid onto the exhaust gas, and depositing the circulating liquid having the impurities suspended therein;
continuously removing the impurities from the circulating liquid by capturing and filtering the circulating liquid having the impurities suspended therein; and
packing the impurities removed from the circulating liquid into containers.

9. The method as claimed in claim 8, wherein the step of continuously removing the impurities is carried out during an exhaust-gas processing operation.

10. The method as claimed in claim 8, wherein
the step of continuously removing the impurities includes the steps of:
separating the impurities by capturing and filtering the circulating liquid having the impurities suspended therein; and
separating the impurities by filtering a liquid formed by turning the impurities separated by the first filter into slurry and collecting the slurry, and
the step of packing the impurities includes packing the impurities separated by the step of filtering the liquid into containers.

11. The method as claimed in claim 10, wherein the step of separating the impurities by filtering the liquid includes supplying filtrate processed by the step of separating the impurities by capturing and filtering the circulating liquid, and turning the impurities separated by capturing and filtering the circulating liquid into the slurry.

12. The method as claimed in claim 8, wherein the step of packing the impurities is carried out in a negatively-pressurized, hermetically-sealed state.

13. The method as claimed in claim 8, wherein the exhaust gas is an exhaust gas emitted during a sulfuric acid process in copper smelting.

14. The method as claimed in claim 8, wherein the particulate impurities contain a valuable metal, and the valuable metal is collected into the containers.
